(19) United States
(12) Patent Application Publication
(10) Pub. No.: US 2011/0219309 A1
(43) Pub. Date: Sep. 8, 2011

(54) VIDEO DISPLAY SYSTEM AND DISPLAY CONTROL METHOD

(76) Inventors: Takayuki YAMAGUCHI, Yokohama (JP); Atsushi Maruyama, Yokohama (JP); Kazuhiko Aoshima, Sagamihara (JP)

(21) Appl. No.: 12/912,860

(22) Filed: Oct. 27, 2010

(30) Foreign Application Priority Data
Mar. 5, 2010 (JP) 2010-048575

(51) Int. Cl. G06F 3/048

(52) U.S. Cl. 715/722; 715/719

(57) ABSTRACT

In a video display device for use in presentation, a display state on computer display screen of an application software program used in the presentation is detected. When it is detected that the application software is in a maximized display state, a video image is projected from a video display device; upon detection of any other states, a user's designated video non-display state is set up. An objective of using this arrangement is to automatically switch it to disappearance of a display image of the video display device or to displaying of an alternative image, thereby to improve the user's usability relating to non-display of a desktop image which can contain therein unexpected important information.

### INCORPORATION BY REFERENCE

This application claims priority from Japanese Patent Application JP 2010-048575, filed on Mar. 5, 2010, the content of which is hereby incorporated by reference into this application.

### BACKGROUND OF THE INVENTION

The present invention relates to a video display system capable of displaying video images of a computer and also relates to a control technique useful for display output control of video images to be output from the computer.

In cases where a presentation is performed using a liquid crystal display (LCD) projector which is connected to a personal computer (PC), it is a general way to use a presentation application software program to visually display presentation materials on the PC's display screen and electrically connect together this PC and the LCD projector by a video cable for causing presentation images, which are the same as PC display images, to be optically projected from the LCD projector on a large-size screen.

The PC for use in such presentation comes often with an operating system (OS) having a window-displayable graphical user interface (GUI), such as “Windows” (registered trademark of Microsoft Corporation). This type of OS with the window GUI environment is featured by its ability to allow other application software programs to operate selectively or simultaneously on a display screen called the “desktop” with various kinds of image information, such as icons, being graphically laid out thereon.

When making a presentation using PC, a certain length of time must be taken from the activation or “wakeup” of PC, such as material search and startup of a presentation-assisting application software, up to the on-screen visualization of a material required. Within this time period, the PC's desktop image is to be displayed on the projection screen due to the fact that simultaneous display of the PC's display image and LCD projector image is being performed. This visualization of the desktop display image is also performed in the same way in the case of performing a presentation material changing work.

While various kinds of information are contained in the PC's desktop display image as stated above, a presentation conductor (i.e., presenter) rarely pays attention to the content of such desktop display image; so, there is a risk that unexpected important information in this desktop display image is unintentionally displayed on the projection screen. In light of the fact that the information security is becoming important more and more in recent years, this risk is not negligible in any way.

One known approach to solving this problem is to use a screen nonvisualization function (i.e., blanking function) that is built in the LCD projector or, alternatively, cut off the transmission of a video signal from a signal source by unplugging a video signal cable that couples the PC and video display device together or by deactivating video output of an external video output terminal of the PC through a manual operation on the PC side. For example, JP-A-2004-21054 discloses therein a technique for judging a video signal to perform video processing, such as video muting or the like.

### SUMMARY OF THE INVENTION

In prior known video display systems of the type using a PC and LCD projector, an operator who performs presentation (presenter) is required to keep in mind a present display state of the LCD projector as stated previously. However, this human action is a troublesome work, and is easily forgettable; thus, there was a problem that undesirable data is carelessly opened to the audience of such presentation.

The present invention has been made in view of the technical background stated above, and an object of this invention is to provide a video image display apparatus or device for use in presentation, which is capable of making its display images invisible in those times other than a presentation material displaying time period or, alternatively, switching them to a substitute image in an automated way, thereby improving the user's usability of the video display device.

To attain the foregoing object, in accordance with one aspect of this invention, a video display system is provided which is arranged to have a computer with a plurality of software programs installed therein for performing window display operations respectively and a video display device which is connected to the computer for visually displaying image data of the computer, wherein the system includes at least one video output program which is contained in the plurality of programs that are operable on the computer, and a monitoring or “surveillance” program for monitoring a display state of the video output program, and wherein when the display state of the video output program is a predetermined state, the monitor program validates or invalidates (i.e., enables or disables) a display output of the video output program.

The video display device of this invention is also arranged so that an external video output terminal of the computer is connected to the video display device by a video transmission means, wherein the monitor program permits, when a present display state of the video output program is a predetermined state, a display data of the video output program to be output from the external video output terminal of the computer, and, in the other cases, prevents the display data of the video output program from being output from the external video output terminal of the computer.

The video display device of this invention is also arrangeable so that the external video output terminal of the computer is connected to the video display device by a video transmission means, wherein the monitor program causes, when a present display state of video data of the video transmission means is a prespecified state, a display data of the video output program to be visually displayed; in the remaining cases, it sets the video display device in a predefined state.

According to the invention as disclosed herein, it is possible to readily display only presentation video images on the LCD projector screen. This makes it possible to improve the security of the video display system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing one example of a configuration of a signal source used in either a first embodiment or second embodiment of this invention.

FIG. 2 is a flow chart showing an operation of a monitoring application software program which is installed in a PC in the first embodiment.

FIGS. 3A to 3C are diagrams showing maximized, size-reduced and minimized display states of an application software program which is a target object to be monitored by the monitoring application software and which is displayed on a window GUI-based OS in the first embodiment, the second embodiment and a third embodiment.

FIG. 4 is a block diagram showing one example of a configuration of a video system in the first embodiment, which system causes video data to be transferred between the signal source and video display device by a transmission method other than those using a video cable.

FIG. 5 is a flowchart showing an operation of monitoring application software in the second embodiment.

FIG. 6 is a block diagram showing one example of a connection arrangement between the signal source and video display device in the third embodiment.

FIG. 7 is a flowchart showing an operation of monitor application software in the third embodiment.

FIG. 8 shows, in block diagram form, a configuration of video display system embodying the invention.

### DESCRIPTION OF THE EMBODIMENTS

A video display system incorporating the principles of this invention is arranged to detect the display state of a specific screen image which is not wanted to be visualized on a presentation or the like and then control, based on this detection result, the actual display content and/or display output. Regarding the screen display state to be detected here, control may be performed by detecting a screen image(s) to be displayed during the presentation or else.

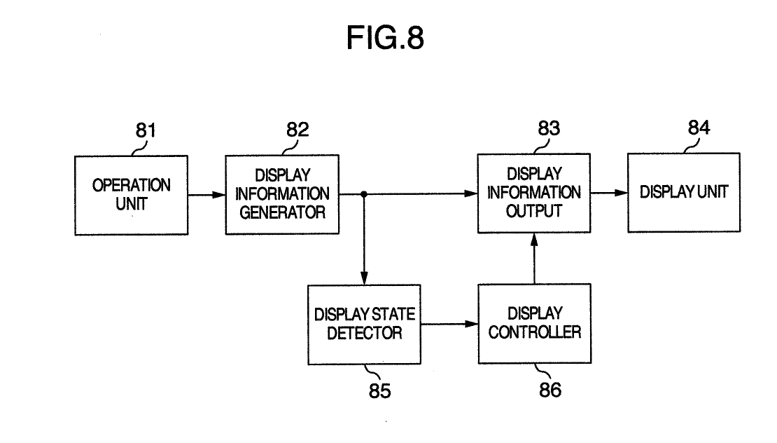

FIG. 8 shows in block diagram form a configuration of the video display device of this invention. The illustrative video display device embodying the invention includes an operation unit 81 which performs issuance of instructions as to display operations of a presentation or else, a display information generation unit 82 which generates display information of the presentation or else, and a display information output unit 83 which outputs the display information to a display unit 84. Using these units, the device performs image display of the presentation or else. At this time, a display state detection unit 85 operates to monitor or “watchdog” the information being currently displayed. Based on a monitoring result, the display information output unit 83 is controlled by a display control unit 86 to thereby change the display of a screen image to be output to the display unit 84.

The video display system in accordance with this invention is also arranged so that a computer capable of operating a plurality of application software programs simultaneously or selectively running one of them in a switched way and a video display device are connected together by either a video cable or any one of other cables with the video data transmission capability. While an operation is performed, on the computer's display screen, to detect a display state of an application software program which is used in the presentation, when it is detected that the application software's window is displayed on an entirety of the display screen or that the displayed application window occupies 80% or more of the display screen area (referred to as the “maximized display state” hereinafter), a video image is optically projected from the video display device; upon detection of other display states, control is provided to set up a video non-display state which is designated by a user.

In a case where the above-noted display state detection is performed by the computer, a monitoring application software program is used therefor, which has its function for enabling or “validating” an external video output when the application software's window is currently in the maximized display state, and for disabling or “invalidating” the external video output when the application software is in the other display states. The video display device controls the display state in conformity to this enabling/disabling management of the external video output.

In cases where there is performed a network presentation which includes capturing a computer screen image and transmitting the captured image data via a universal serial bus (USB) cable or by way of a radio data transmission method, such as wireless local area network (LAN) or the like, a need is felt to install in the computer a presentation data transmission application software program; in view of this, the above-stated monitoring application software may be designed to have this function therein.

In case a single-task OS-installed computer is used, an application software program to be used may be arranged to have the above-stated function. This is also usable in the case of using a multitask OS.

It is also considered that the above-stated detection result is notified by communication control to the video display device. Based on the content notified, the video display device performs switching between a video display state and the user's designated video nondisplay state.

In case the detection is performed by the video display device, this device is arranged to have a function of detecting whether the on-screen window of an application software program in the image data as sent from the computer is coexistent with a characteristic part of the maximized display state, e.g., a task bar on the display screen of Windows OS and “Start” button on the left end side thereof, to thereby detect the maximized display state and other display states, and a function which is responsive to receipt of the detection result for displaying the transmitted image data when the maximized display state is detected and for setting up the user's designated video nondisplay state in the case of those display states other than the maximized display state.

An example of the user's designated video nondisplay state is a blanking display for visualizing an image painted by one specific color. Another example of it is to display an image, such as the logo of a manufacturer. Further, this may also be achieved by deactivation of light emission of a light source or by temporal light shielding of the light source.

Illustrative embodiments of the video display system of this invention will be described in detail below. An embodiment 1 and embodiment 3 are the ones that apply the principal concept of this invention to a video display system of the type having a computer with a presentation application software program being operable thereon and a video display device, such as a liquid crystal display (LCD) projector, wherein the computer and the LCD projector are connected together by a video cable or a communication cable. The embodiments 1 and 3 are the ones that show examples of the control for displaying different video images in responding to a display state detection result. An embodiment 2 is the one that applies this invention to the inside of a computer with the presentation application software operating therein.

Note here that in these embodiments, a Window OS-installed personal computer (PC) is used as a signal source of the video display device. The same goes for the case of using a PC in which is installed another window GUI-based OS, such as Mac OS™, Linux™ or the like.

Although in the embodiments a projection-type LCD projector is used as the video display device, this may be replaceable by other similar suitable devices or equipments. In respective figures of the drawings, those parts or components having a common function are designated by the same reference numeral, and duplicative explanations of once-described components will be eliminated for purposes of avoiding redundancy.

### Embodiment 1

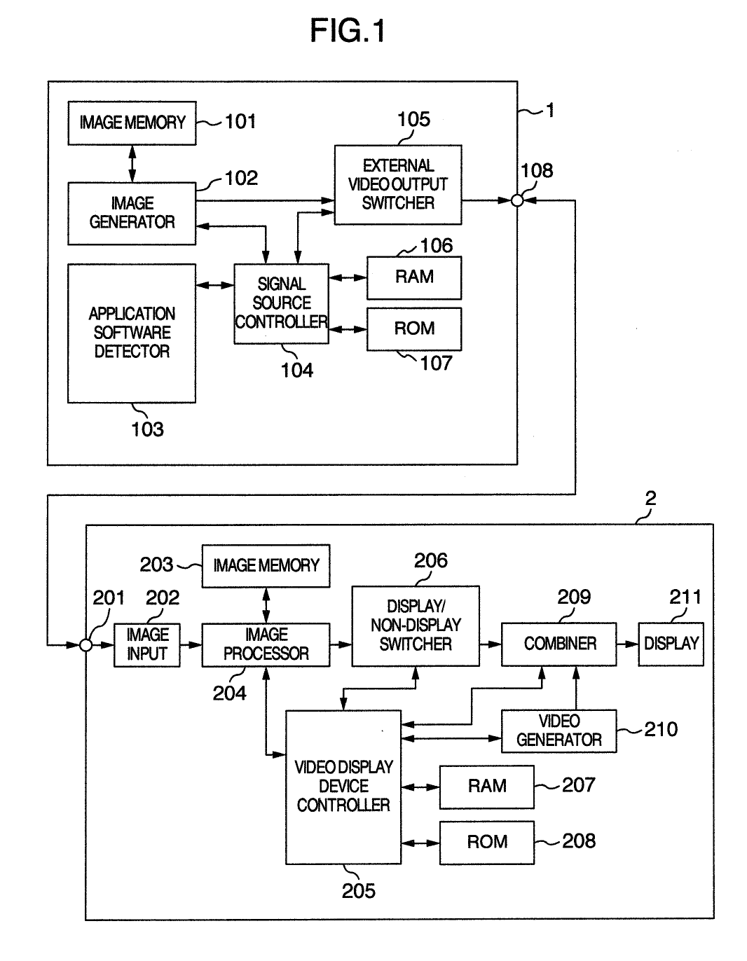

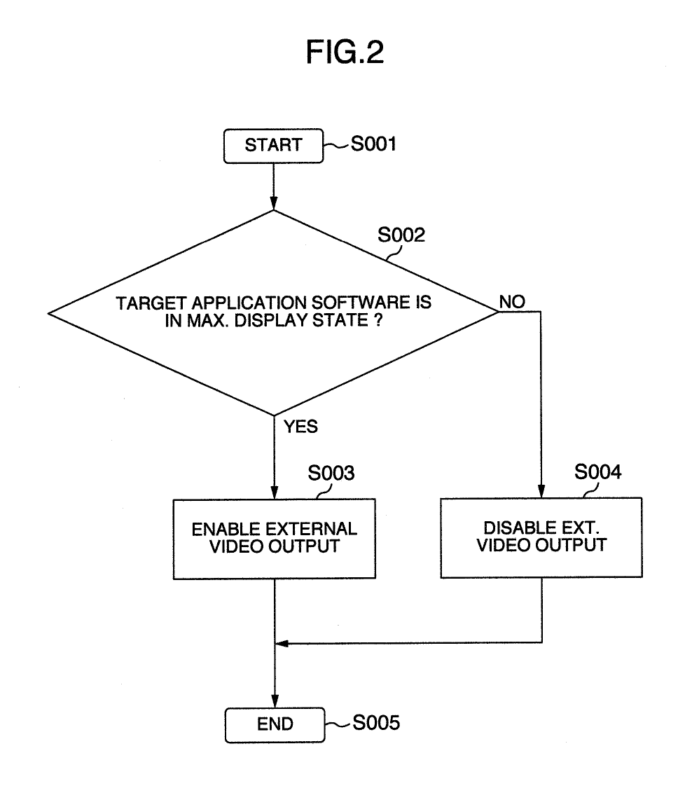

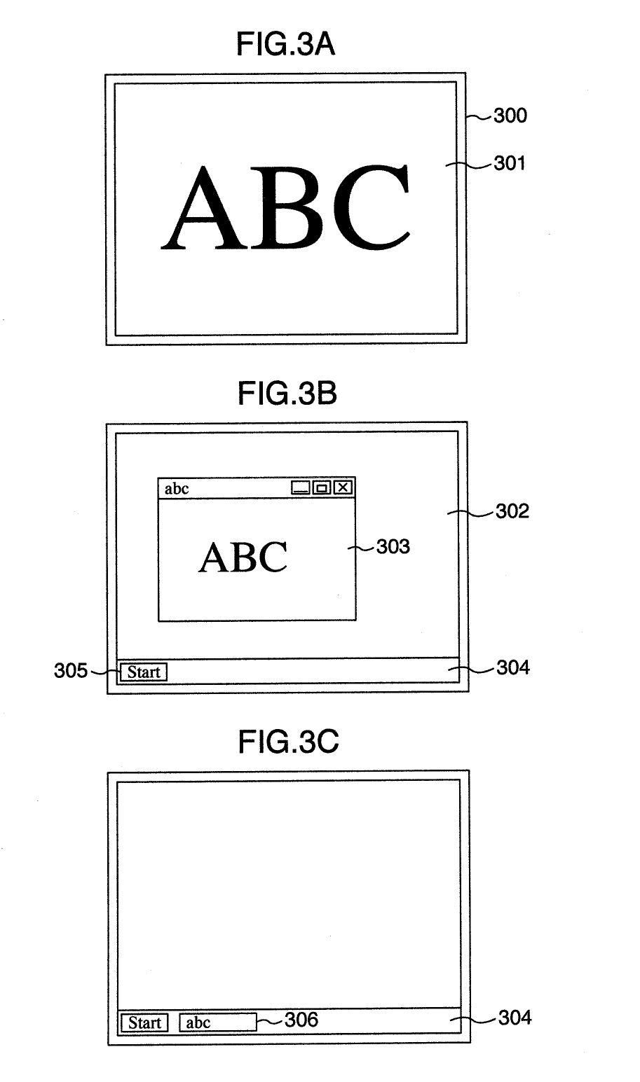

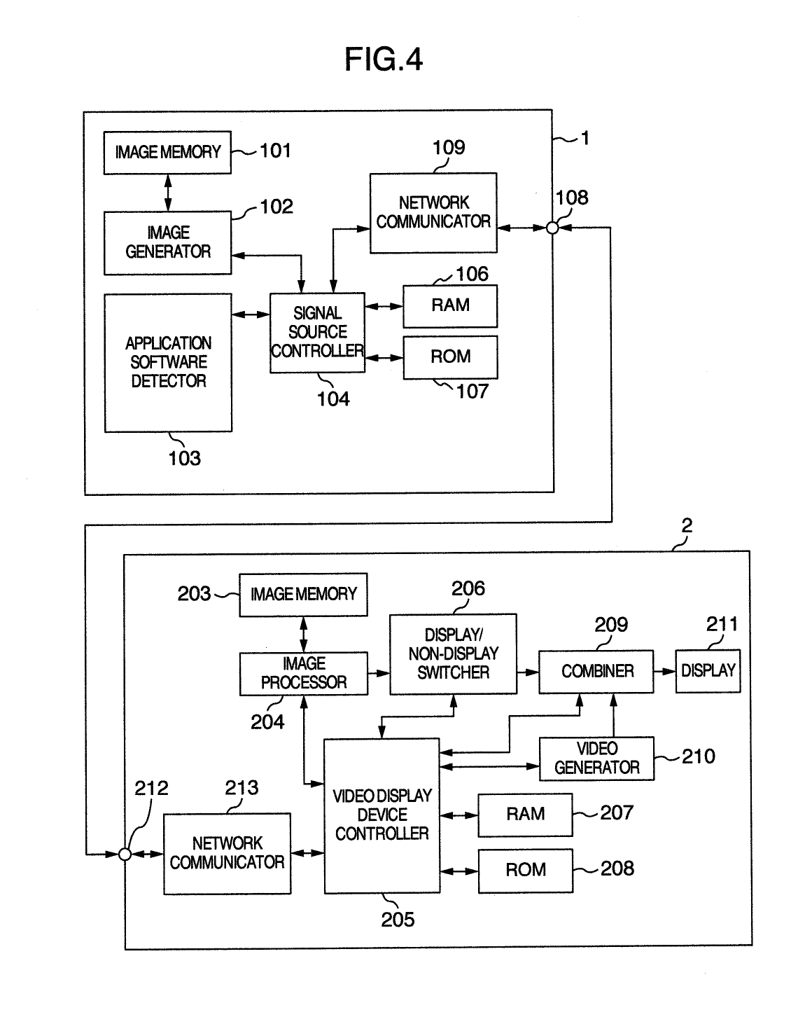

An explanation will now be given of the first embodiment that applies this invention to a signal source, with reference to FIG. 1, FIG. 2, FIGS. 3A-3C and FIG. 4. FIG. 1 is a block diagram showing one example of a configuration of the signal source and a video display device used in the embodiment of this invention. More precisely, the signal source may be a PC which is operatively associated with the video display device, such as LCD projector, for displaying video images on a large-size screen by use of an application software program.

In FIG. 1, reference numeral “1” is used to designate the signal source; numeral 101 indicates an image memory; numeral 102 denotes an image generation unit; 103 is an application software detection unit; 104, a signal source control unit; 105, an external video output switching unit. The image memory 101, image generator unit 102, application software detector unit 103 and external video output switcher unit 105 are controlled by the signal source controller 104.

FIG. 2 is a flowchart showing an operation of the application software detector unit 103. In this embodiment, the signal source 1 performs detection of whether the application software is in a maximized display state or in other display states in a way pursuant to the flowchart shown in FIG. 2.

As shown in FIG. 2, the detection procedure starts with step S001 and then proceeds to step S002. Before the start step S001, a monitoring or “surveillance” application software program which executes the procedure shown in this flowchart is installed in advance in the signal source 1. It is also required as its initial setting that those applications to be monitored by this software are registered.

At step S002, a decision is made to specify whether an application software program to be monitored is in the maximized display state or in other display states, by means of a certain software interface as provided by the OS manufacturer. For example, “GetWindowPlacement( )” is used, which is an application programming interface (API) function of the OS.

FIGS. 3A to 3C are diagrams showing three typical display states of the application software to be monitored by the monitor application software, which runs on the OS having the window GUI in accordance with the embodiment of this invention. FIG. 3A depicts a maximized display state of a window, FIG. 3B shows a size-reduced display state of the window, and FIG. 3C shows a minimized display state of the window.

Numeral “300” designates an image display area of the PC; numeral 301 denotes the maximized display state of the application software to be monitored by the monitor application software; 303 indicates the reduced display state of the application software to be monitored; 304 is a task bar of window; 305, a start button to be displayed on the taskbar; 306, the minimized display state of the application software.

At step S002 in the flowchart of FIG. 2, when the to-be-monitored application software is in the maximized display state 301, that is, if “Yes” determination at this step, the procedure proceeds to step S003. Alternatively, when the to-be-monitored application software is in other display states, such as the reduced display state 303 and minimized display state 306, i.e., if “No” at step S002, the procedure goes to step S004.

The step S003 is for enabling the external video output; to do this, control is provided to set the external video output switcher 105 to being enabled. The step S004 is for disabling the external video output, by setting the external video output switcher 105 to disabled.

More specifically, the video display system in accordance with the embodiment of this invention is arranged to include a means for detecting on the signal source side a display state of an application software program designated, and a means operatively responsive to receipt of a detection result obtained by the detection means, for switching between the enabling setup and disabling setup of an external video output, wherein a video signal is output to the video cable only when the external video output is made valid.

FIG. 4 is a block diagram showing one example of a configuration of video system which permits video data to be sent by a signal transmission method other than the video cable between the signal source and the video display device in accordance with another embodiment of this invention. Examples of the video transmission method as used herein include, but not limited to, a wire cable, such as USB or LAN or the like, and a radio transmission technique, such as wireless LAN or else.

In FIG. 4, numeral 109 designates a network communication unit as built in the PC for use as the signal source; 213 denotes a network communication unit in the LCD projector 2. Note here that the network communication unit 109 is controlled by the signal source controller 104, for example. The network communication unit 213 is controlled by a video display device control unit 205, for example.

The system configuration shown in FIG. 4 is also employable in cases where a special-purpose application software program accepts or “imports” PC images without the use of any video cable by way of USB or wireless LAN connection or else and then uses a network cable to transmit such image data to the video display device.

In this case, a method is also employable, which does not perform switching between the enabling setup and the disabling setup of an external video output, but performs an operation which follows: in a case where the to-be-monitored application software is in the maximized display state 301, let the image data be transmitted directly; in case the software is in other display states than the maximized display state, an alternative or substitute image which is saved either in a storage device that is internally built in the video display device or in a storage device as externally connected thereto is sent as the image data. Alternatively, it is also possible to prevent transmission of a new image data and continue transmission of its prior image data.

Regarding the substitute image transmission function, this may be built in an application software program for importing images to be sent via the network. With the arrangement stated above, it is possible in this embodiment to improve the user's usability in terms of protection of information leakage or divulgation.

### Embodiment 2

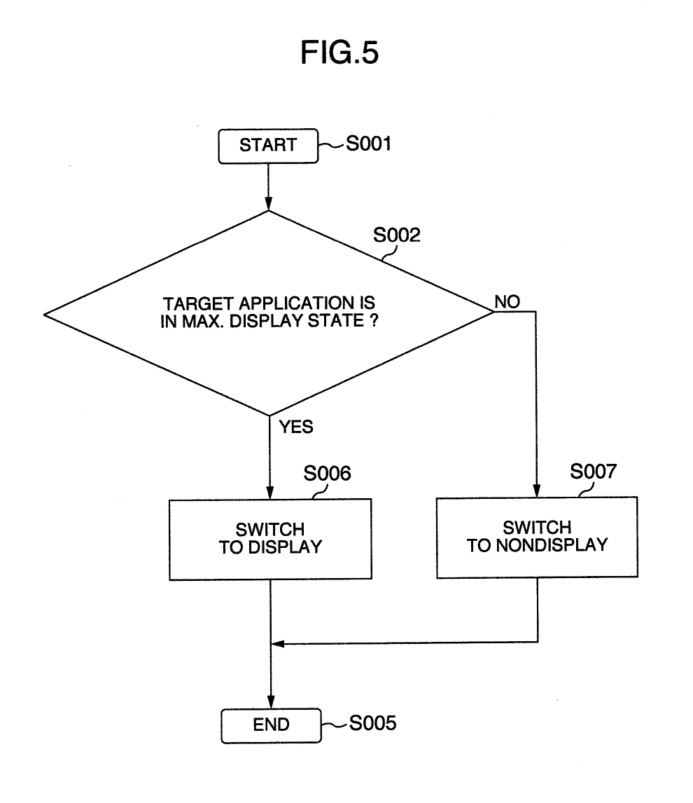

The second embodiment incorporating the principles of this invention will be described using FIG. 1, FIGS. 3A-3C and FIG. 5.

FIG. 1 is a block diagram showing an exemplary configuration of the signal source and video display device used in the embodiment of this invention. Reference numeral 202 denotes an image input unit; numeral 203 indicates an image memory; 204 is an image processing unit; 205, a video display device control unit; 206, a display/non-display switching unit. The image memory 203, image processor unit 204, display/nondisplay switcher 206 are controlled by the video display device controller 205, for example. The image memory 203 and image processor 204 is constituted from a semiconductor memory device(s), for example, in which is stored the information concerning the image data acquired at the image input unit 202.

In this embodiment, the video display device 2 operates to inspect those images held in the image memory 203 and image processor 204 to thereby perform detection of whether the application software of interest is in the maximized display state or in other states.

FIG. 5 is a flowchart showing an operation of the video display device in accordance with the embodiment of this invention. After startup at step S001, the procedure proceeds to step S002 which determines whether an input image data is in its maximized display state. If this is the case, i.e., if “Yes” at step S002, the procedure goes to step S006. When the image data is in other display states, i.e., if “No” at step S002, go to step S007.

It is noted here that at step S002, an attempt is made to detect whether the application software in the image data that was sent from the computer is coexistent with a characteristic portion of the maximized display state, e.g., the taskbar 304 of Windows and the start button 305 on the left end side. In case the taskbar 304 and start button 305 are detected, it is determined that a present state is not the maximized display state. This maximized display state determination may alternatively be made in a way depending upon the presence or absence of a predefined display pattern which is unique to the application software.

The step S006 of FIG. 5 is for setup of display with respect to the display/nondisplay switcher 206. The step S007 is to set the display/nondisplay switcher 206 to nondisplay. The display/nondisplay switcher 206 is arranged to perform displaying by replacement with a specific image for the nondisplay event use, e.g., the manufacturer's logo, a one-color-painted image or the like, to thereby achieve the displaying of the image data as sent from the PC in the case of the maximized display state only. Other examples of the nondisplay event-use screen image to be generated by the display/nondisplay switcher 206 include an image data stored in the internal memory of the video display device or saved in an external memory which is connected thereto by a control line. The display/nondisplay switcher 206 may also be arranged to attain the nondisplay function by means of the blockage of light from its associative light source or by turning off the light source to stop its light emission.

In short, the video display system in accordance with the embodiment of this invention is arranged to include a means for detecting a present display state of the application software in the image data transmitted, and a means for performing switching between video image display and nondisplay in response to the detection result stated supra.

With the above-stated arrangement, it is possible in this embodiment to improve the user's usability in terms of the information divulgation. In the case of the light source emission turn-off technique is employed as the nondisplay method, it is also possible to achieve further reduction of electrical power consumption. Additionally, limiting unnecessary display operations makes it possible to provide the video display device capable of preventing a system component performance/quality degradation otherwise occurring due to the prolonged use of the light source and LCD panel, thereby extending the length of lifetime.

### Embodiment 3

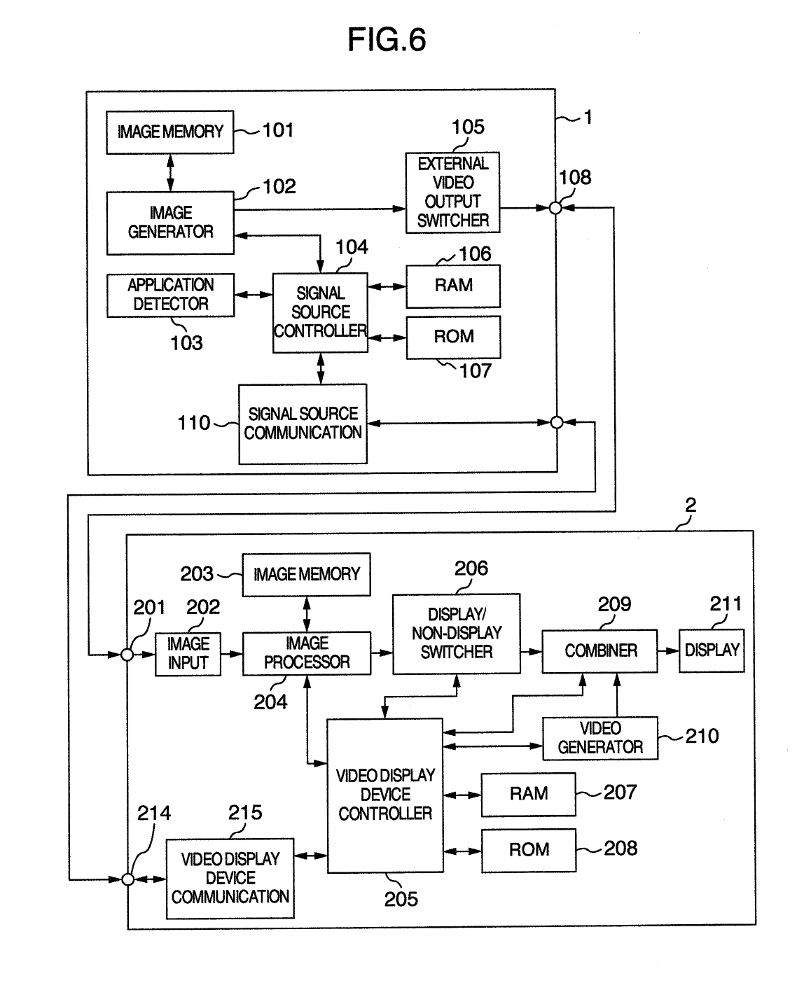

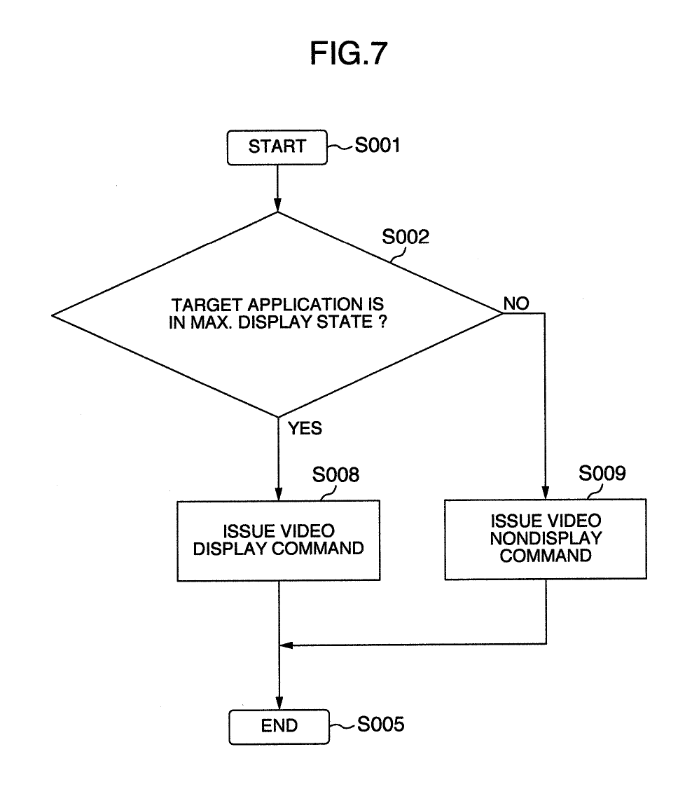

An explanation will be given of the third embodiment of this invention with reference to FIGS. 6 and 7, which embodiment applies the concept of the invention to a video display system having a signal source and a video display device that are connected together by a video cable and a communication cable. FIG. 6 is a block diagram showing one example of a connection arrangement between the signal source and video display device in accordance with the third embodiment of this invention. Numeral 110 designates a signal source communication unit whereas numeral 215 indicates a video display device communication unit.

In the system shown herein, the image memory 101, image generator 102, application software detector 103, external video output switcher 105 and signal source communication unit 110 are controlled by the signal source control unit 104, for example. The image memory 203, image processor 204, display/nondisplay switcher 206 and video display device communication unit 215 are controlled by the video display device controller 205, for example.

FIG. 7 is a flowchart showing an operation of a monitoring application software program in accordance with the embodiment of this invention, which shows a routine procedure to be executed at the application software detector unit 103. In this embodiment, the signal source 1 operates in compliance with the flowchart shown in FIG. 7 to perform detection of whether the application software of interest is currently in its maximized display state or in other display states and then notify its detection result to the video display device 2 using its associated communication device.

The procedure starts at step S001 and goes next to step S002 which detects whether the to-be-monitored application software is in its maximized display state or not. Note here that before the start step S001, a monitoring application software program which executes the procedure of the flowchart shown in FIG. 7 is installed in advance in the signal source 1. It is also necessary as the initial setting to register one or more application software programs to be monitored by this software are registered.

When the to-be-monitored application software is currently in the maximized display state, i.e., if “Yes” at step S002, the procedure proceeds to step S008. Alternatively, when the to-be-monitored application software is in a display state other than the maximized display state, i.e., if “No” at step S002, the procedure goes to step S009.

The step S008 is for using the signal source communication unit 110 to generate and issue a video display command, which is supplied to the video display device 2. The step S009 is for using the signal source communication unit 110 to issue a video nondisplay command, which is then sent to the video display device 2. The video display device controller 205 is responsive to the received content of the video display device communication unit 215 that has received the video display command, for executing either the video display command or the video nondisplay command with respect to the display/nondisplay switcher 206.

The display/nondisplay switcher 206 has its nondisplay execution module, which performs the required display operation by replacement with a specific nondisplay-use signal, e.g., the manufacturer's logo or a unicolor-painted image, thereby to realize the displaying of the image data as sent from the PC in the case of the maximized display state only. As for the nondisplay-use screen image of the display/nondisplay switcher 206, other methods are also employable, including a method of using image data stored in the internal memory of the video display device or in an external memory connected thereto via a control line.

Regarding the above-noted substitute image data, an image data to be sent via the communication-use control line may alternatively be used. As for the nondisplay setting means of the display/nondisplay switcher 206, this may alternatively be achieved by either blockage of light from its associative light source or turn-off of light emission of the light source.

In summary, the video display system in accordance with this embodiment of the invention is specifically arranged to include the means for detecting a present display state of the application software registered, and the means for notifying a detection result to the video display device by use of the communication device and for performing switching between video output display and nondisplay.

With the above-stated arrangement, it is possible in this embodiment to improve the user's usability. In addition, by using the light source emission turn-off technique as the nondisplay method, it becomes possible to further reduce electric power consumption, thereby making it possible to provide the intended video display device or apparatus capable of preventing or at least greatly suppressing the system component performance/quality degradation otherwise occurring due to the prolonged use of the light source and LCD panel to thereby increase the lifetime thereof.

It should be noted that this invention should not be interpreted to be directly limited to the illustrative embodiments and may be implementable by variously modifying its constituent components without departing from the scope of the invention. In addition, by appropriate combination of two or more components used in the embodiments as disclosed therein, it is possible to make various inventions. For instance, some parts or components may be deleted from the overall components shown in the embodiments. Furthermore, one or more components used in an embodiment may be combined with those of a different embodiment.

According to the embodiments of this invention, in a case where the application software designated is in the maximized display state, the video image of such application software per se is displayed; in cases where the software is in other display states, there is automatically executed the work for switching it to the user's designated display state, such as the blanking or the like. Thus, it is possible to prevent divulgation of information otherwise occurrable due to unintentional visualization of a desktop screen image during a file access operation or else, while at the same time improving the user's usability.

Other approaches to realizing the above-stated user's designated video nondisplay state include a method for displaying the manufacturer's logo or advertisement image(s). Use of this method makes it possible to provide a video display device of the type having advertising effectiveness.

Another example of the above-stated user's designated video nondisplay state is the use of a method for deactivating the light emission of the light source. By stopping the light emission of light source, it is possible to lessen electric power consumption. It is also possible to provide the intended video display device capable of preventing or minimizing the system component degradation otherwise occurring due to the prolonged use of the light source and LCD panel to thereby lengthen the lifetime thereof.

It should be further understood by those skilled in the art that although the foregoing description has been made on embodiments of the invention, the invention is not limited thereto and various changes and modifications may be made without departing from the spirit of the invention and the scope of the appended claims.

1. A video display system comprising a computer with a plurality of programs installed therein for performing window display operations respectively and a video display device connected to the computer for displaying image data of said computer, wherein said video display system includes:
at least one video output program included in the plurality of programs operable on said computer; and
a monitor program for monitoring a display state of the video output program, and wherein
when the display state of said video output program is a predetermined state, said monitor program renders a display output of said video output program valid or invalid.

2. The video display system according to claim 1, wherein an external video output terminal of said computer and said video display device are connected together by a video transmission means,
said monitor program causes, when the display state of said video output program is the predetermined state, a display data of said video output program to be output from the external video output terminal of said computer, and
in other cases, said monitor program prevents the display data of said video output program from being output from the external video output terminal of said computer.

3. The video display system according to claim 1, wherein an external video output terminal of said computer and said video display device are connected together by a video transmission means,
said monitor program causes, when a display state of a video data of said video transmission means is a predetermined state, a display data of said video output program to be displayed, and
in other cases, said monitor program sets said video display device in a prespecified display state.

4. The video display system according to claim 1, wherein said computer and said video display device are connected together by a data communication means,
said video output program sends, when the display state of said video output program is a predetermined state, a display data of said video output program from said computer to said video display device via the data communication means, and
in other cases, sets said video display device in a predefined display state via said data communication means.

5. The video display system according to claim 1, wherein said computer and said video display device are connected together by a video transmission means and a data communication means,
when the display state of said video output program is a predetermined state, said monitor program sends a display data of said video output program from said computer to said video display device via said video transmission means while letting a video display command be notified by said data communication means from said computer to said video display device, and
in other cases, a video non-display command is notified by said data communication means from said computer to said video display device.

6. The video display system according to claim 1, wherein said monitor program detects whether a display area size of said video output program is substantially equal to a display screen size of a video signal to be output from said computer.

7. The video display system according to claim 1, wherein said monitor program detects any one of a display data of said video output program and a video signal to be output from said computer contains therein a specific kind of information.

8. The video display system according to claim 2, wherein when said monitor program detects that the display state of said video output program is not in a predetermined state, said video display device displays an image data being stored in a storage device as a display state being set up by a user.

9. The video display system according to claim 2, wherein when said monitor program detects that the display state of said video output program is not in a predetermined state, said video display device displays an image painted by a specific kind of color.

10. The video display system according to claim 2, wherein when said monitor program detects that the display state of said video output program is not in a predetermined state, said video display device performs any one of stoppage of light emission of a light source and light shielding of the light source.

11. The video display system according to claim 2, wherein when said monitor program detects that the display state of said video output program is not in a predetermined state, said video display device lowers video luminance.

12. The video display system according to claim 2, wherein when said monitor program detects that the display state of said video output program is not in a predetermined state, said video display device displays a specific image as sent from said computer.

13. A display control method for use with a computer having a plurality of programs installed therein for performing window display operations, said method comprising the steps of:
monitoring a display state of a program;
determining whether a display area size of the program is equal to a display screen size of a video signal to be output from said computer;
when the display area size is equal to the display screen size, outputting a display data of said program to a video signal; and
when the display area size is not equal to the display screen size, preventing output of the display data of said program to the video signal.

14. The display control method according to claim 13, wherein when the display area size of said program is not equal to the display screen size of a video signal to be output from said computer, a prespecified kind of display data is output to the video signal.

15. The display control method according to claim 13, wherein when the display area size of said program is not equal to the display screen size of a video signal as output from said computer, video displaying is not performed.

16. A display control method for use with a computer having two or more programs installed therein for performing window display operations, said method comprising the steps of:
monitoring a display state of a program;
determining whether a specific kind of information is contained in a display image of said program;
when the information is contained therein, outputting a display data of said program to a video signal; and
when the information is not contained, preventing output of the display data of said program to the video signal.

17. The display control method according to claim 16, wherein when the specific information is not contained in the display image of said program, a prespecified type of display data is output to the video signal.

18. The display control method according to claim 16, wherein when the specific information is not contained in the display image of said program, image displaying is not performed.
